(19) United States
(12) Patent Application Publication
(10) Pub. No.: US 2011/0036598 A1
(43) Pub. Date: Feb. 17, 2011

(54) APPARATUS AND METHOD FOR FIRE PROTECTION FOR STORAGE OCCUPANCIES

(75) Inventor: Oliver S. Pahila, Liberty, SC (US)

Correspondence Address: FITZPATRICK CELLA HARPER & SCINTO, 1290 Avenue of the Americas, NEW YORK, NY, 10104-3800, US

(73) Assignee: The Reliable Automatic Sprinkler Co., Inc., Liberty, SC (US)

(21) Appl. No.: 12/867,742

(22) PCT Filed: Feb. 13, 2009
(86) PCT No.: PCT/US09/34130

§ 371 Date: Oct. 18, 2010

Related U.S. Application Data
(60) Provisional application No. 61/028,418, filed on Feb. 13, 2008.

(51) Int. Cl. A62C 37/08

(52) U.S. Cl. 169/37

(57) ABSTRACT

A fire protection method is provided that comprises providing at least one special application control mode extended coverage sprinkler for storage applications having a K-factor of at least 14 that is connectable to a piping network to protect commodity hazards including class one through four and cartoned unexpanded plastics, as defined in National Fire Protection Association Standard 13 and FM Global Property Loss Prevention Data Sheets 8-1 and 8-9, stored in a storage area defined by a storage height of at least 25 feet, and a building height of at least 30 feet, wherein the sprinkler provides coverage to an area of at least 144 square feet. The method also includes connecting the at least one sprinkler to the overhead piping network at a height at least equal to the storage height, activating the sprinkler in the event of a fire condition sensed by the sprinkler head, and delivering a fluid fed to the sprinkler to a coverage area of at least 144 square feet.

### BACKGROUND OF THE INVENTION

This application claims the benefit of priority under Article 4 of the Paris Convention for the Protection of Industrial Property to U.S. provisional patent application 61/028,418, filed Feb. 13, 2008, the entire contents of which, including Appendices 1-5, are incorporated by reference as if fully set for herein. Also, this application refers to U.S. patent application Ser. No. 11/408,868, filed on Apr. 20, 2006, the entire contents of which are incorporated by reference as if fully set forth herein.

### Field of the Invention

The present invention relates to an automatic fire protection sprinkler and a method of fire protection for storage occupancies, and in particular an extended coverage, storage special application sprinkler and method of using the same in accordance with a minimum pressure and number of sprinklers to be calculated design criteria.

Fire protection sprinklers conventionally are connected to a conduit to receive pressurized fire-extinguishing fluid, such as water. A typical sprinkler has a base with a threaded portion for connection to the conduit and an output orifice to output the fluid to provide fire control and/or suppression. The output orifice is sealed by a seal cap, which is held in place by a release mechanism. The release mechanism is designed to release the cap under predetermined conditions, thereby initiating the flow of fire-extinguishing fluid. A typical release mechanism includes a thermally-responsive element, e.g., a frangible bulb or fusible link, and may also include a latching mechanism.

Certain conventional sprinklers have a pair of arms that extend from the base portion and meet at a hub portion to form a frame. The hub portion is spaced apart from the output orifice of the base portion and is aligned with a longitudinal axis thereof. The hub portion may have a set-screw configured to apply a pre-tension force to the release mechanism. A deflector may be mounted on the hub, transverse to the output orifice, to provide dispersion of the output fluid.

Fire protection sprinklers may be mounted on a fluid conduit running along a ceiling and may either depend downward from the conduit, which is referred to as a “pendent” configuration, or may extend upward, which is referred to as an “upright” configuration. Alternatively, a sprinkler may be mounted on a wall, a certain distance below the ceiling, which is referred to as a “horizontal sidewall” configuration. Horizontal sidewall sprinklers have an output orifice that is oriented so that the fluid is output horizontally and sprays onto an area to be protected in front of the sprinkler.

An “extended coverage storage sprinkler (density/area),” as described in Section 5.11 of UL 199 (“Standard for Automatic Sprinklers for Fire-Protection Service,” Underwriters' Laboratories, 11^{th} Ed., Nov. 4, 2005) is a sprinkler that is intended to be installed using the extended coverage area (e.g., 14 feet by 14 feet) and density/area criteria specified in NFPA 13 (“Standard for the Installation of Sprinkler Systems,” National Fire Protection Association, Inc., 2002 Edition). These sprinklers incorporate a heat responsive element and release mechanism that has a response time equal to or less than a standard response sprinkler used on sprinklers designed for standard spacings (e.g., 12 feet by 12 feet).

NFPA 13 defines a number of different types of storage sprinklers. Section 12.7.2, for example, provides “Sprinkler Design Criteria for Storage and Display of Class I through Class IV Commodities, Cartoned Non-Expanded Group A Plastics, and Non-Expanded Exposed Group A Plastics in Retail Stores.” In such applications, the sprinkler must be connected to a wet pipe system designed to meet two separate design points: 0.6 gpm/ft² density over 2000 ft² and 0.7 gpm/ft² density for the four hydraulically most demanding sprinklers (e.g., the four sprinklers furthest from the source).

A fire protection sprinkler can also be characterized by size according to a K-factor defined by K=Q/\sqrt{p}, where Q is the flow rate in gallons per minute and p is the residual pressure at the inlet of the sprinkler in pounds per square inch.

NFPA 13-1999, section 5-4.1.2 states that “For general storage, rack storage, rubber tire storage, roll paper storage, and baled cotton storage being protected with spray sprinklers with required densities of 0.34 gpm/ft² (13.9 mm/min) or less, standard response sprinklers with a nominal K-factor of 8.0 or larger shall be used. For required densities greater than 0.34 gpm/ft² (13.9 mm/min), standard response spray sprinklers with a K-factor of 11.2 (161) or larger that are listed for storage applications shall be used.”

Modifications to NFPA 13 standards used for approving control mode storage sprinklers have been proposed that would require sprinklers to be tested according to a fixed inlet pressure and a fixed number of sprinklers calculated, instead of meeting density area requirements. Due to the proposed standards changes, control mode sprinklers approved for use based upon the existing density/area requirements may not meet the proposed standards.

High pile storage as defined by NFPA 13 is solid-piled, palletized, rack storage, bin/box, and shelf storage in excess of 12 feet in height. Commodities can be classified in classes one through four and sub classified into groups A or B plastics. In general building construction and the layout of the storage space below the location of the sprinkler affects the fire protection requirements. Depending on the building layout, sprinklers may be obstructed or unobstructed by objects below them. When a sprinkler is obstructed, the sprinkler must be specifically listed for that application.

Fire sprinklers for storage applications are designed, tested, and installed to provide two different types of protection, fire control or fire suppression. There are various types of storage sprinkler types, density/area control mode (DACM), specific application control mode (SACM), and early suppression fast response (ESFR). Sprinklers may be specified as standard coverage or extended coverage sprinklers. Standard coverage corresponds to a sprinkler which can provide coverage up to 100 ft² (9.3 m²). Extended coverage corresponds to a sprinkler which can provide coverage of 196 ft² (37.2 m²) or more. In general automatic fire protection sprinkler systems are designed and installed according to FM Global Property Loss Prevention Data Sheet 2-8N, entitled ‘Installation of Sprinkler Systems’.

Density/area control mode (DACM) fire protection sprinklers are specified according to a specific water density delivered by the sprinkler over a specified area of coverage. Fire control using density/area sprinklers limits the size of the fire by decreasing the heat release rate, pre-wetting adjacent combustibles, and controlling ceiling gas temperature to avoid structural damage. Some factors affecting the system design for density/area protection are the commodity sought to be protected, the storage arrangement, the storage height, the clearance from the top of the storage to the ceiling sprinklers, flue spaces, shelving, encapsulation, and aisle width. In order to properly design a system based upon a control mode density/area requirement, it is necessary to account for the type of piping system the sprinklers will be used in (i.e., wet or dry pipe system), the clearance between the sprinklers and the commodity, the temperature rating of the sprinkler, and whether sprinklers will be used in the storage racks. Typically, density/area sprinklers are selected and used according to classification of use in an appropriate NFPA 13 density/area table and applying a correct modifying factor based on one or more of the factors noted above to determine the suitable sprinkler. Selecting the wrong table or misapplication of any of the modifying factors can be detrimental to providing adequate fire control. Typical standard coverage density/area sprinklers have K-factors that include 5.6, 8.0, 11.2, 14.0, and 16.8, and typical extended coverage density/area sprinklers have K-factors of 25.2 and above.

Control mode specific application (CMSA) sprinklers limit the size of the fire by decreasing the heat release rate, pre-wetting adjacent combustibles, and controlling ceiling gas temperature to avoid structural damage. CMSA sprinklers are designed and tested for specific storage applications, such as heights, commodities, etc. Commodities may be classified according to FM Global Property Loss Prevention Data Sheet 8-9, entitled ‘Storage Of Class 1, 2, 3, 4 and Plastic Commodities’. Systems using this type of sprinkler are designed according to FM Global Property Loss Prevention Data Sheet 2-7, entitled ‘Installation Rules For Sprinkler Systems Using Control Mode Specific Application (CMSA) Ceiling Sprinklers For Storage Applications’. CMSA sprinklers are specified according to a minimum inlet pressure of the fire protection fluid. However, unlike density/area control mode (DACM) sprinkler systems, those system using CMSA sprinklers are designed according to the listing criteria of the sprinkler and whether the sprinkler is used in a wet or dry pre-action system. The characterization of a CMSA sprinkler is based on actual fire testing of the sprinkler using a minimum inlet pressure to the sprinklers and a specified minimum number of sprinklers to be calculated to cover a specific area. As a result, when designing a fire protection system using CMSA sprinklers, no reference to density/area charts or curves or the application of modifying factors is necessary, which can reduce errors in selecting system components caused by use of such tables.

ESFR sprinklers use fast response mechanisms to deliver large quantities of water to penetrate a fire plume to the burning fuel surface and sharply reduce the heat release rate to prevent regrowth of the fire. One advantage of ESFR sprinklers is that sprinklers need not be placed within a storage rack of a commodity, providing flexibility in locating storage racks and commodities in a storage area, such as a warehouse. However, ESFR sprinklers can only be used in wet pipe systems for special application use and they are especially sensitive to obstructions caused by building configurations. Moreover, use of ESFR sprinklers in a special application environment requires a high pressure fluid source, which increases the cost and complexity of the system, whether for new construction or for retrofitting existing buildings. In some cases, retrofitting the fire protection system with an ESFR sprinkler system for a special application use may require redesign of the building structure. Some examples of typical obstructions include cross-bracing or bridging in rafters of buildings below the sprinkler head, light fixtures below the sprinkler head, duct work, cable trays, and conduits below the sprinkler head. Moreover, since ESFR sprinklers are standard-coverage, a greater number of sprinklers are used to provide fire protection than if extended coverage sprinklers were used.

### SUMMARY OF THE INVENTION

In one aspect of the invention, a fire protection method is provided that comprises providing at least one special application control mode extended coverage sprinkler for storage applications having a K-factor of at least 14 that is connectable to a piping network to protect commodity hazards including class one through four and Group A cartoned unexpanded plastics, as defined in National Fire Protection Association Standard 13 and FM Global Property Loss Prevention Data Sheets 8-1 and 8-9, stored in a storage area defined by a storage height of at least 25 feet, and a building height of at least 30 feet, wherein the sprinkler provides coverage to an area of at least 144 square feet. The method also includes connecting the at least one sprinkler to the overhead piping network at a height above the storage height, activating the sprinkler in the event of a fire condition sensed by the sprinkler head, and delivering a fluid fed to the sprinkler to a coverage area of at least 144 square feet.

In another aspect of the invention, a fire protection sprinkler system is provided.

Another aspect of the invention provides a special application control mode extended coverage sprinkler for storage applications having a K-factor of between 14 and 28.

In one aspect, the present invention provides a pendent fire protection sprinkler, including a deflector having a first pair of opposed slots, a second pair of opposed slots at about 90° from the first pair of slots, a third pair of opposed slots, positioned between both the first and second pairs of opposed slots, and a plurality of angled slots, positioned between the first and third pairs of opposed slots and the second and third pairs of opposed slots.

Embodiments of the present invention may include one or more of the following features.

The deflector may be a planar, circular disk having a radius of about 1.6-2.1 inch. The first and second pairs of opposed slots may have a radial length of about 0.4-0.5 inch. The third pair of opposed slots may have a radial length of about 0.5-0.7 inch. The angled slots may have a radial length of about 0.15-0.20 inch.

The first and second pairs of slots may have a radial length of about 20-30% of a radius of the deflector. The third pair of opposed slots may have a radial length of about 28-38% of a radius of the deflector. The angled slots may have a radial length of about 7-12% of a radius of the deflector.

A center line of the angled slots may form an angle of about 20°-50° with respect to a radial line extending from a center of the deflector through inner ends of the angled slots. The inner ends of the angled slots may be positioned about 15°-30° from the nearest slot of the first and second pairs of slots. The third pair of opposed slots may form an angle of about 40°-50° with the first and second pairs of slots.

The sprinkler may achieve a water discharge density of 0.6 gpm/ft.² density over an area of 2000 ft.², and the nominal K-factor may be 25.2.

In another aspect, the present invention provides a pendent fire protection sprinkler for storage applications, having a body including a fluid passage and an output orifice sealed with a seal cap, two arms extending from the body and meeting at a hub, a release mechanism with a thermally-responsive element positioned between the seal cap and the hub, and a deflector positioned on the hub and facing the output orifice. The deflector includes a plurality of aligned slots at about 90° from each other, a plurality of corner slots located between the aligned slots, and a plurality of angled slots located between the aligned slots and the corner slots.

These and other objects, features and advantages will be apparent from the following description of the preferred embodiments of the present invention.

### BRIEF DESCRIPTION OF THE DRAWINGS

The present invention will be more readily understood from a detailed description of the preferred embodiments taken in conjunction with the following figures.

FIG. 1 is a perspective view of a pendent sprinkler in accordance with the present invention and used in the method of the present invention.

FIG. 2 is a sectional view of the pendent sprinkler of FIG. 1, in a plane perpendicular to the plane of the frame arms.

FIG. 3 is a plan view of the deflector of the sprinkler of FIG. 1, showing the surface that faces away from the outlet orifice.

FIG. 4 is an elevation view of a test array configured in accordance with an embodiment of an aspect of the invention.

FIG. 5 is a plan view of the test array of FIG. 4.

### DETAILED DESCRIPTION OF THE PREFERRED EMBODIMENTS

In a first aspect of the invention a special application control mode extended coverage sprinkler for storage applications is provided that connects to a piping network to protect commodity hazards including class one through four and cartoned unexpanded plastics stored in a storage area in accordance with National Fire Protection Association Standards 13. The special application control mode extended coverage sprinkler for storage applications includes a body defining a passageway between an inlet and an outlet along a longitudinal axis with the outlet closer to an area to be protected than the inlet, the passageway having a rated K-factor of at least 14, and preferably at least 25.2. The sprinkler also includes a closure positioned proximate the outlet opening so as to occlude the passageway in an unactuated position, a heat responsive trigger that retains the closure to occlude the passageway, and a deflector assembly. The deflector assembly can distribute fluid fed to the inlet while providing coverage of at least up to 144 square feet to protect commodity hazards including class one through four and Group A cartoned unexpanded plastics stored in a storage area defined by a storage height of at least 25 feet, and a building height of at least 30 feet when the heat responsive trigger is actuated to permit flow through the outlet.

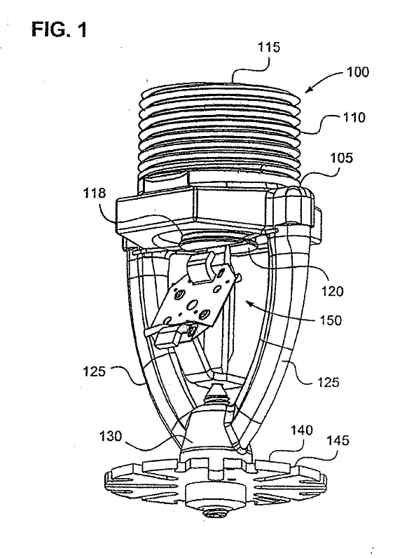

FIG. 1 shows a pendent sprinkler 100, that can be used in accordance with the present invention, having a body 105 defining an axial fluid passage and which may have the features of any of the sprinklers disclosed in copending U.S. patent application Ser. No. 11/408,868. The top of the body has a threaded portion 110 on its outer surface to allow the sprinkler to be connected to a conduit (not shown) for providing pressurized fire-extinguishing fluid, such as water, to an input end 115 of the fluid passage. The fluid passage has an output orifice 118 at the opposite end that is sealed by a seal cap 120. The input end 115 may have a diameter of, for example, 1 inch NPT (national pipe thread). The sprinkler may have a K-factor of, for example, 25.2, which as mentioned above is defined by K=Q/\sqrt{p}, where Q is the flow rate in gallons per minute and p is the residual pressure at the inlet of the sprinkler in pounds per square inch.

Two frame arms 125 extend from the lower portion of the body 105 and meet at a hub 130 positioned below and in axial alignment with the output orifice 118. A deflector 140 is positioned on the hub 130 so as to be impinged by the output fluid upon activation of the sprinkler 100. As further discussed below, the deflector 140 in this particular embodiment is a circular, planar disk that is centered on and orthogonal to the axis of the fluid passage. The disk has a number of slots 145 of varying length and orientation arrayed around its periphery.

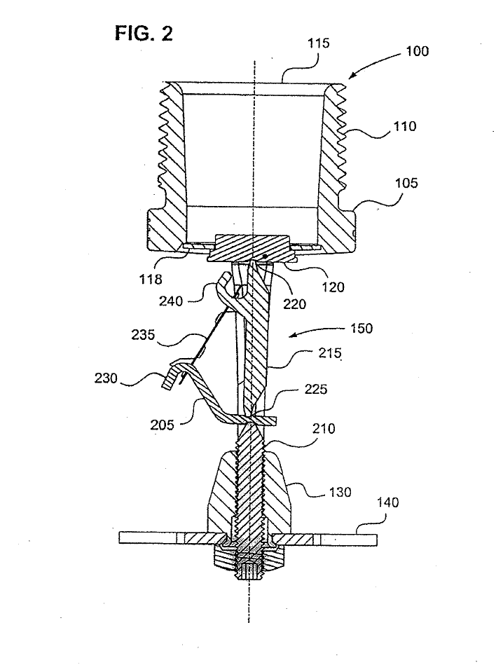

A release mechanism, e.g., a fusible link assembly 150, having a thermally-responsive element, e.g., a fusible link 235, is positioned between the hub 130 and the seal cap 120 to hold the seal cap in place over the output orifice 118. As shown in the sectional view of FIG. 2, the link assembly 150 includes a lever 205 positioned on a set screw 210 that extends upward from the hub 130. A strut 215 is positioned between the seal cap 120 and the lever 205, such that one end of the strut 215 is positioned in a slot 220 on the surface of the seal cap 120 and the other end of is positioned in a slot 225 on the lever, slightly offset from the set screw 210.

The pressure of the fluid on the seal cap 120 causes a downward force on the strut 215, which in turn causes the extended end 230 of the lever 205 to tend to rotate away from the strut 215 (i.e., the lever 205 rotates counter-clockwise in the view of FIG. 2). The rotational force on the lever 205 creates a tension force on the fusible link 235, which is attached between the extended end 230 of the lever 205 and a hook 240 on the upper portion of the strut 215.

The fusible link 235 comprises two thin, metal plates, e.g., beryllium-nickel alloy, one connected to the lever 205 and the other connected to the strut 215. The plates are joined in an overlapping manner with solder that melts at a predetermined temperature. The link 235 separates at the predetermined temperature, due to the tension force applied by the lever 205 and the strut 215, allowing the lever 205 and the strut 215 to swing outward. This in turn releases the seal cap 120 and allows the fluid to be output from the orifice 118. Of course, other types of release mechanisms may be used, including, but not limited to, for example, a frangible bulb or a sensor, strut, and lever assembly.

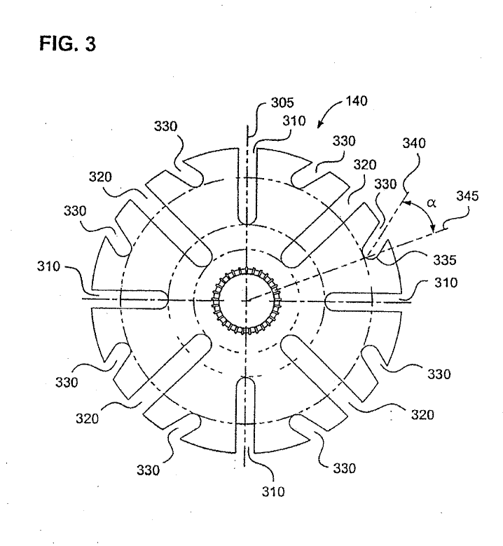

FIG. 3 shows an embodiment of the deflector 140, which as noted above, is a circular, planar disk having a number of slots of varying length and orientation arrayed around its periphery. The deflector 140 may be formed, for example, of phosphor bronze and may have a radius of about 1.85 inches and a thickness of about 0.08 inch. The deflector 140 may be planar, as shown in this embodiment, or may be curved or bent, so that an outer portion of the deflector 140 extends away from the outlet orifice 118.

The positions of the slots may be described in terms of the approximate angle between each slot and a reference line 305 extending vertically though the planar view of the disk in FIG. 3. In the exemplary embodiment, there is a set of four slots 310 in a perpendicular configuration (“the aligned slots”), each having a radial length of about 0.46 inches (which is about 25% of the deflector radius) and a width of about 0.11 inches. In alternative embodiments, the length of these slots may vary by up to about ±15%.

There is also a set of four slots 320 at 45° from the reference line 305, each having a radial length of about 0.61 inches (about 33% of the deflector radius) and a width of about 0.125 inches (the “corner slots”). In alternative embodiments, the length of these slots may be vary by up to about ±15%.

There is also a set of eight slots 330 (“the angled slots”) that are oriented to form an angle (α) of about 35° between center lines 340 of the angled slots 330 and radial lines 345 passing through inner ends 335 of the angled slots 330 (i.e., passing through the origin of the radius of the inner end). In alternative embodiments, the angle α may vary between about 20°-50°. The angled slots have a radial length (i.e., the distance from the inner end to the outside edge of the deflector along the radial line 345) of about 0.175 inches (about 9% of the deflector radius) and a width of about 0.1 inches. In alternative embodiments, the length of these slots may be vary by up to about ±15%. The inner ends 335 of the angled slots 330 are positioned about midway between the aligned slots 310 and the corner slots 320, i.e., the angled slots 330 are at about 22.5° or at about 67.5° from the reference line.

The slots discussed above have rounded inner ends that are approximately semicircular, with a radius equal to half the slot width, but other geometries may also be used. Of course, the deflector may have other slots in addition to those described above.

In accordance with UL 199, storage, area/density sprinklers are tested in a large scale fire test, in which an array of sprinklers is installed over predetermined configurations of commodities, e.g., a double-row rack of standard, cartoned Group A plastic commodities, beneath a smooth, flat, non-combustible ceiling. The water flow from the sprinklers must be controlled by the deflector to achieve an output pattern that meets the required water discharge density specified for the sprinkler. Representative sample sprinklers are installed at a specified spacing for each fire test, which is 14 feet for K-25.2 extended coverage sprinklers. The ignition point for the fire test is positioned either beneath a single sprinkler, between two sprinklers on the same branch line, or in the center of four sprinklers (i.e., at the center of a square 14 feet on each side).

In order to maintain the proper density of water output over the specified area, the sprinkler 100 must have a spray pattern that is approximately square. Thus, the sprinkler 100 must be configured to throw water farther in the direction of the corner slots 320 (45° from the reference line 305), relative to the aligned slots 310 (0° and 90° from the reference line 305). This is particularly so for the test in which the ignition point is centered between four sprinklers, because the ignition point will be aligned with the corner slots 320 of each of the four sprinklers (i.e., in the corner of the approximately square pattern of each sprinkler).

To achieve the approximately square output pattern, the corner slots 320 are designed to be somewhat longer than the aligned slots 310, in order to project more water toward the corners of the spray pattern. Likewise, the angled slots 330 are angled toward the corners of the output pattern, which further tends to create a square pattern. In addition, directing the output spray toward the corners of the spray pattern lessens the amount of water output toward adjacent sprinklers. This helps prevent “cold soldering,” which is a condition in which water is output by a sprinkler directly onto an adjacent sprinkler, thereby lowering the temperature of the adjacent sprinkler and preventing it from properly activating. Moreover, the longer corner slots 320 extend to the outside diameter of the hub in order to deliver a thrust force (stream of water directed straight downward for single head protection when fire occurs directly underneath the head. Tests have been conducted with a single sprinkler directly overhead a fire and it has been verified that that sprinkler actuated and did control the fire.

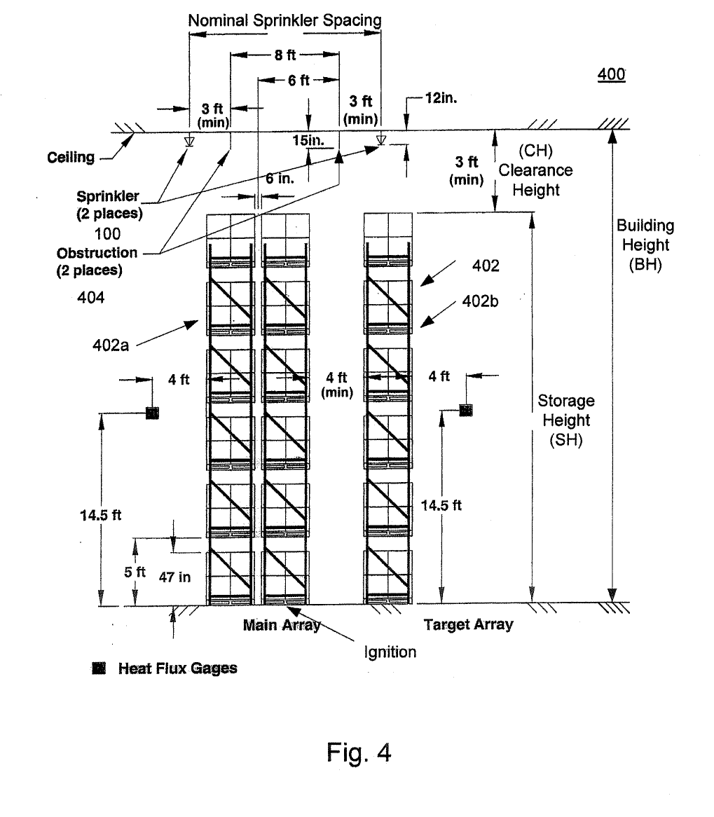

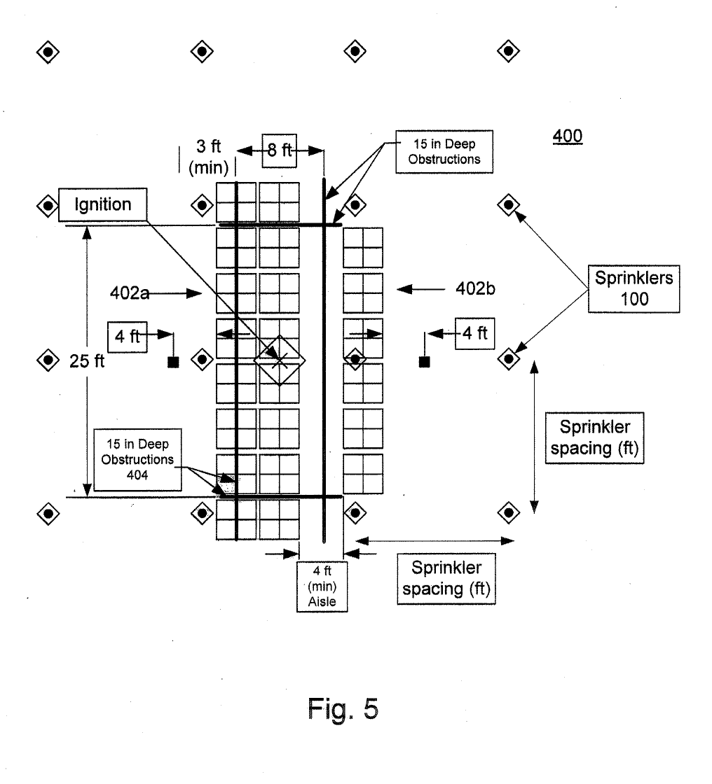

An example embodiment of the extended coverage sprinkler discussed above, such as that shown in FIG. 1, has also been tested according to the proposed fixed pressure/fixed number of sprinklers calculated design requirements described above. FIGS. 4 and 5 show a testing configuration used to test the sprinkler according to the proposed fixed pressure/fixed number of sprinklers design requirements. The arrangement of the commodity hazard shown as an elevation view in FIG. 4 is representative of a test arrangement used by FM Global in evaluating the performance of various embodiments of the invention described herein. The control mode storage special application storage sprinklers configured in accordance with the invention are tested in a large scale fire test, in which an array of sprinklers is installed over predetermined configurations of commodities, e.g., a double-row rack of standard, cartoned Group A unexpanded plastic commodities, beneath a smooth, flat, non-combustible ceiling. The sprinklers are located at a predetermined distance (clearance height, CH) above the top of a commodity hazard having a storage height (SH) and are located another predetermined distance below the ceiling of a building having a building height (BH). In one embodiment the minimum clearance height is 3 feet Representative sample sprinklers are installed at a specified spacing for each fire test, which is, in one embodiment, 14 feet for K-25.2 extended coverage sprinklers. The ignition point for the fire test is positioned either beneath a single sprinkler, between two sprinklers on the same branch line (as shown in FIGS. 4 and 5), or in the center of four sprinklers (i.e., at the center of a square 14 feet on each side). Such sprinklers are tested at various building heights, storage heights, and inlet fluid pressures to the sprinklers. The water flow from a minimum number of activated sprinklers is controlled by the deflector to effectively protect a certain coverage area below the sprinklers when the sprinklers are positioned at a certain spacing from one another.

An example embodiment of a sprinkler configured in accordance with the invention having a K-factor of 25.2 was tested over a class I-IV and Group A cartooned unexpanded plastic hazard having a storage height of 25 feet. The building height was 30 feet. The sprinklers were connected to the piping network running between the sprinklers and the building ceiling that is capable of delivering fluid to any activated sprinklers at a pressure of at least 30 psi. The sprinklers were tested with a maximum spacing of 14 feet×14 feet. The fire test was conducted and showed that 6 sprinklers would protect a 1200 square foot area. Under those conditions, the sprinkler was deemed to be compliant with FM Global Property Loss Prevention Data Sheets 2-8N classification of occupancies, including classes I-IV and Group A cartoned unexpanded plastics, for commodities in any or all of the following configurations: solid-piled, palletized, shelved, bin-boxed, open frame single row racks (SRR), double row racks (DRR), multiple row racks (MRR), or portable rack storage.

The extended coverage sprinkler shown in FIG. 1, was further tested according to the proposed fixed pressure/fixed number of sprinklers calculated design requirements described above. In particular, a sprinkler configured in accordance with the invention having a K-factor of 25.2 was tested with a fixed inlet pressure of 40 psi gauge. The test was conducted for protecting a storage area having a storage height of 30 feet and a building height of 35 feet. The sprinkler was tested with a maximum spacing of 12 feet×12 feet. In the testing it was found that 9 sprinklers would protect an area of 1200 square feet. Under those conditions, that sprinkler was deemed to be compliant with FM Global Property Loss Prevention Data Sheets 2-8N classification of occupancies, including classes I-IV and Group A cartoned unexpanded plastics, for commodities in any or all of the following configurations: solid-piled, palletized, shelved, bin-boxed, open frame single row racks (SRR), double row racks (DRR), multiple row racks (MRR), or portable rack storage.

The extended coverage sprinkler shown in FIG. 1, was further tested according to the proposed fixed pressure/fixed number of sprinklers calculated design requirements described above. In particular, a sprinkler configured in accordance with the invention having a K-factor of 25.2 was tested with a fixed inlet pressure of 60 psi gauge. The test was conducted for protecting a storage area having a storage height of 35 feet and a building height of 40 feet. The sprinkler was tested with a maximum spacing of 12 feet×12 feet. During the testing up to 9 sprinklers opened. Under those conditions, that sprinkler was deemed to be compliant with FM Global Property Loss Prevention Data Sheets 2-8N classification of occupancies, including classes I-IV and Group A cartoned unexpanded plastics, for commodities in any or all of the following configurations: solid-piled, palletized, shelved, bin-boxed, open frame single row racks (SRR), double row racks (DRR), multiple row racks (MRR), or portable rack storage.

In another aspect of the invention, a fire protection method is provided that comprises providing at least one special application control mode extended coverage sprinkler for storage applications having a K-factor of at least 14. The sprinkler provided is connectable to a piping network to protect commodity hazards including class one through four and Group A cartoned unexpanded plastics, as defined in National Fire Protection Association Standard 13 and FM Global Property Loss Prevention Data Sheet 2-8N. The protected commodity hazards are stored in a storage area defined by a storage height that is at least 25 feet, and a building height of at least 30 feet. The sprinkler also provides coverage to an area of at least 144 square feet (i.e., 12 feet×12 feet spacing). The method also includes connecting the sprinkler(s) to the overhead piping network at a height at least equal to the storage height, activating the sprinkler(s) in the event of a fire condition sensed by the sprinkler, and delivering a fluid fed to the sprinkler spaced at a sprinkler nominal spacing of at least 12 feet×12 feet. The sprinkler(s) is(are) connected to the overhead piping network at a predetermined distance above the storage height and below the building height. For example, in one embodiment, a deflector of the sprinkler is disposed at least 3 feet above the storage height and at least 1 foot below the building height.

As discussed above, FIG. 4 shows a sprinkler system that is configured in accordance with an embodiment of the fire protection method and apparatus described above. In FIG. 4 a plurality of sprinklers 100 are connected to an overhead piping network (not shown). The sprinklers 100 can have a nominal K-factor between 14 and 28. The sprinklers 100 and the piping network are located at a predetermined distance (clearance height, CH) above the top of a commodity hazard 402 having a storage height (SH) and are located another predetermined distance below the ceiling of a building having a building height (BH). The minimum clearance height of the sprinklers 100 above the commodity hazard 402 is 3 feet. The building height can be between 30 and 45 feet and the storage height can be between 25 and 40 feet. The commodity hazard 402 is arranged as shown as a first commodity storage array 402a and a second commodity storage array 402b. The storage arrays 402a and 402b are shown separated by an aisle having a certain minimum width. Various obstructions may be present in the building such as beams, pipes, ceiling mounted equipment, etc. Such obstructions can trap heat rising during a fire condition below the obstruction, possibly resulting in delayed activation of sprinklers near the obstruction from the delay in sensing a temperature rise. As shown in FIG. 4, two obstructions 404 running above and parallel to arrays 402a, b are 15 inches long and are located between the sprinklers 100. The sprinklers are positioned a certain minimum distance from the obstructions 404. In the following embodiments, the sprinklers 100 are positioned at least 3 feet from the obstructions 404.

For example, in a first embodiment, the nominal storage height is 25 feet and the nominal building height is 30 feet, the sprinklers 100 are connected to the piping network about 12 inches below the ceiling (i.e., building height) and three feet above the commodity, and the piping network is capable of supplying fluid to the connected sprinklers 100 at at least 30 pounds per square inch. The sprinkler preferably has a K-factor of 25.2. In FIG. 4 two rows of sprinklers 100 are spaced at a nominal spacing of 14 feet. However, in other embodiments, the sprinklers 100 may be spaced apart at other nominal spacings, such as at least 12 feet. In FIG. 4, the sprinklers 100 are spaced 14 feet apart above a first commodity storage array 402a and a second commodity storage array 402b, both of which are arranged as double row racks. The aisle width between the storage arrays 402a and 402b is a minimum of 4 feet.

FIG. 5 shows a plan view of the sprinkler system shown in FIG. 4 in which a plurality of sprinklers 100 are spaced apart from one another in a grid pattern above the first and second commodity storage arrays 402a, b. The sprinklers are spaced apart at a nominal sprinkler spacing of 14 feet. Such sprinklers 100 are preferably configured according to the embodiments described herein and in copending U.S. patent application Ser. No. 11/408,868. In the event of a fire condition sensed by one or more of the sprinklers 100 connected to the piping network (not shown), fluid is delivered to each activated sprinkler(s) 100 at a pressure of at least 30 psi. In the first embodiment, up to 6 sprinklers 100 are provided to effectively protect an area of about 1200 square feet containing class one through four and Group A cartoned unexpanded plastics discussed above. It should be noted that while up to 6 sprinklers 100 may be provided, fewer than that number of sprinklers 100 may activate during a fire condition. The system demand during sprinkler activation is nominally 830 gallons per minute. Where the demand coverage area is 1200 square feet or less the hose stream allowance is 250 gallons per minute for 1 hour, while for demand areas greater than 1200 square feet, the hose stream allowance is 500 gallons per minute for 1.5 hours. Moreover, while FM Global limits the system design criteria to a minimum of 6 sprinklers per 1200 square feet, further testing indicates that using at least another embodiment of the invention, as few as 4 sprinklers 100 can be provided to satisfy the testing requirement set by FM Global for coverage of an area of 1200 square feet. The reduction in the required number of sprinklers 100 for the given coverage area is advantageous because the water demand can be reduced while also reducing the cost and complexity of the system 400.

In a second embodiment of the method, a plurality of sprinklers 100 having a K-factor of 25.2, such as those sprinklers configured herein and according to copending U.S. patent application Ser. No. 11/408,868 are provided and connected to the piping network at a sprinkler spacing of 12 feet. As shown in FIG. 5, the sprinklers 100 are connected to the piping network below the ceiling of a building having a nominal building height of 35 feet. Moreover, the sprinklers 100 are located above the first and second commodity storage arrays 402a, b shown in FIGS. 4 and 5 having a nominal storage height of 30 feet. The sprinklers 100 are positioned 3 feet above the top of the first and second commodity storage arrays 402a, b. In the event of a fire condition sensed by one or more of the sprinklers 100, fluid is delivered to the activated sprinkler(s) 100 at a pressure of at least 40 psi. In the second embodiment, up to 9 sprinklers 100 are provided to protect an area of about 1200 square feet containing class one through four and Group A cartoned unexpanded plastics discussed above. The system 400 demand during sprinkler 100 activation is nominally 1435 gallons per minute.

In yet a third embodiment of the method, a plurality of sprinklers 100 having a K-factor of 25.2, such as those sprinklers 100 configured as described herein and according to copending U.S. patent application Ser. No. 11/408,868, are provided and connected to the piping network at a sprinkler spacing of 12 feet. As shown in FIG. 5, the sprinklers 100 are connected to the piping network below a ceiling of a building having a nominal building height of 40 feet. Moreover, the sprinklers are located above the first and second commodity storage arrays 402a, b having a nominal storage height of 35 feet. The sprinklers 100 are positioned 3 feet above the top of the first and second commodity storage arrays 402a, b. In the event of a fire condition sensed by one or more of the sprinklers, fluid is delivered to the activated sprinkler(s) at a pressure of at least 60 psi. In the second embodiment, up to 6 sprinklers are provided to protect an area of about 1200 square feet containing class one through four and Group A cartoned unexpanded plastics discussed above.

In another aspect of the invention a fire protection sprinkler system is provided that includes at least one sprinkler configured as described herein connected to a fluid supply conduit configured to supply fluid to the activated sprinklers at a certain pressure, such as shown in FIGS. 4 and 5. The sprinklers have a nominal K-factor of at least 14 and are connected to the fluid supply conduit at a spacing of at least 12 feet×12 feet. The sprinkler connected to the fluid supply conduit is configured to deliver fluid over an area of at least 144 square feet over an occupancy hazard including classes I-IV and Group A cartoned unexpanded plastics, as defined by National Fire Protection Association Standard 13 and FM Global Property Loss Prevention Data Sheets 8-1 and 8-9, stored in a storage area defined by a building height of at least up to 30 feet and a storage height of the hazard of at least 25 feet, when the pressure of the fluid entering the sprinkler is at least 30 pounds per square inch. An example of a fire protection sprinkler system in accordance with the invention is shown in FIGS. 4 and 5 where the sprinklers are connected to the fluid supply conduit at a certain distance below the ceiling (at the building height) and above the commodity (the storage height). For example, in one embodiment the sprinklers are positioned one foot below the ceiling and about 4 to 5 feet away from the commodity, but at least 3 feet away. In one embodiment the sprinklers are spaced in a grid 14 feet apart from one another above the commodity, such as is shown in FIG. 5. Various embodiments of the fire protection sprinkler system can be configured using the various embodiments of the fire protection sprinklers described herein.

At least one of the advantages of the extended coverage sprinkler, method, and system described herein are that they eliminates the need for in-rack sprinklers (assuming storage is at least 3 feet below the deflector) while simultaneously providing extended coverage, low pressure, and low flow fluid operation. As a result, the sprinklers, method, and system increase the flexibility of locating storage areas within a building and provide the opportunity to reduce the labor and fire sprinkler system infrastructure costs that would be required for some other types of sprinklers, such as early-suppression fast-response (ESFR) and control mode density-area (CMDA) sprinklers.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims.

What is claimed is:

1. A pendent control mode extended coverage specific application fire protection sprinkler for storage applications, comprising a deflector having:
a first pair of opposed slots,
a second pair of opposed slots at about 90° from the first pair of slots,
a third pair of opposed slots, positioned between both the first and second pairs of opposed slots, and
a plurality of angled slots, positioned between the first and third pairs of opposed slots and the second and third pairs of opposed slots, wherein the sprinkler is configured to deliver fluid over an area of at least 144 square feet over an occupancy hazard including classes I-IV and Group A cartoned unexpanded plastics, as defined by National Fire Protection Association Standard 13 and FM Global Property Loss Prevention Data Sheets 8-1 and 8-9, stored in a storage area defined by a building height of at least 30 feet and a storage height of the hazard of at least 25 feet, when the pressure of the fluid entering the sprinkler is at least 30 pounds per square inch gauge.

2. The sprinkler of claim 1, wherein the sprinkler achieves a water discharge density of 0.6 gpm/ft² density over an area of 2000 ft².

3. The sprinkler of claim 1, wherein the deflector comprises a planar, circular disk.

4. The sprinkler of claim 1, wherein the deflector has a radius of about 1.6-2.1 inches.

5. The sprinkler of claim 4, wherein the first and second pairs of opposed slots have a radial length of about 0.4-0.5 inches.

6. The sprinkler of claim 4, wherein the third pair of opposed slots have a radial length of about 0.5-0.7 inches.

7. The sprinkler of claim 4, wherein the angled slots have a radial length of about 0.15-0.20 inches.

8. The sprinkler of claim 1, wherein the first and second pairs of slots have a radial length of about 20-30% of a radius of the deflector.

9. The sprinkler of claim 1, wherein the angled slots have a radial length of about 7-12% of a radius of the deflector.

10. The sprinkler of claim 1, wherein a center line of the angled slots form an angle of about 20-50° with respect to a radial line extending from a center of the deflector through inner ends of the angled slots.

11. The sprinkler of claim 1, wherein the inner ends of the angled slots are positioned about 15-30° from the nearest slot of the first and second pairs of slots.

12. The sprinkler of claim 1, wherein the third pair of opposed slots form an angle of about 40-50° with the first and second pairs of slots.

13. The sprinkler of claim 1, wherein the third pair of opposed slots have a radial length of about 28-38% of a radius of the deflector.

14. The sprinkler of claim 1, wherein the sprinkler has a nominal K-factor of 14-28.

15. The sprinkler of claim 1, wherein the nominal K-factor of the sprinkler is at least 25.2.

16. A pendent control mode extended coverage specific application fire protection sprinkler for storage applications, comprising a body including a fluid passage and an output orifice sealed with a seal cap, two arms extending from the body and meeting at a hub, a release mechanism with a thermally-responsive element positioned between the seal cap and the hub, and a deflector positioned on the hub and facing the output orifice, the deflector comprising:
a plurality of aligned slots at about 90° from each other;
a plurality of corner slots located between the aligned slots; and
a plurality of angled slots located between the aligned slots and the corner slots, wherein the sprinkler delivers fluid over an area of at least 144 square feet over an occupancy hazard including classes I-IV and Group A cartoned unexpanded plastics, as defined by National Fire Protection Association Standard 13 and FM Global Property Loss Prevention Data Sheets 8-1 and 8-9, stored in a storage area defined by a building height of at least 30 feet and a storage height of the hazard of at least 25 feet, when the pressure of the fluid fed to the sprinkler is at least 30 pounds per square inch gauge.

17. The sprinkler of claim 16, wherein the aligned slots are parallel to or perpendicular to a plane of the arms.

18. The sprinkler of claim 16, wherein the sprinkler achieves a water discharge density of 0.6 gpm/ft² density over an area of 2000 ft².

19. The sprinkler of claim 16, wherein the deflector comprises a planar, circular disk.

20. The sprinkler of claim 16, wherein the deflector has a radius of about 1.6-2.1 inches.

21. The sprinkler of claim 20, wherein the first and second pairs of opposed slots have a radial length of about 0.4-0.5 inches.

22. The sprinkler of claim 20, wherein the corner slots have a radial length of about 0.5-0.7 inches.

23. The sprinkler of claim 20, wherein the angled slots have a radial length of about 0.15-0.20 inches.

24. The sprinkler of claim 16, wherein the aligned slots have a radial length of about 20-30% of a radius of the deflector.

25. The sprinkler of claim 16, wherein the angled slots have a radial length of about 7-12% of a radius of the deflector.

26. The sprinkler of claim 16, wherein a center line of the angled slots form an angle of about 20-50° with respect to a radial line extending from a center of the deflector through inner ends of the angled slots.

27. The sprinkler of claim 16, wherein the inner ends of the angled slots are positioned about 15-30° from the nearest slot of the first and second pairs of slots.

28. The sprinkler of claim 16, wherein the corner slots form an angle of about 40-50° with the aligned slots.

29. The sprinkler of claim 16, wherein the corner slots have a radial length of about 28-38% of a radius of the deflector.

30. The sprinkler of claim 16, wherein the sprinkler has a nominal K-factor of 14-28.

31. The sprinkler of claim 16, wherein the nominal K-factor of the sprinkler is at least 25.2.

32. A fire protection method comprising:
providing at least one control mode extended coverage specific application fire protection sprinkler for storage applications having a K-factor of at least 14 that is connectable to a piping network to protect an occupancy hazard including class one through four and Group A cartoned unexpanded plastics, as defined in National Fire Protection Association Standard 13 and FM Global Property Loss Prevention Data Sheets 8-1 and 8-9, stored in a storage area defined by a storage height of at least 25 feet, and a building height of at least 30 feet;
connecting the at least one sprinkler to the overhead piping network at a height above the storage height, wherein the piping network is configured to supply fluid to the sprinkler at at least 30 pounds per square inch;
activating the sprinkler in the event of a fire condition sensed by the sprinkler; and
delivering the fluid entering the sprinkler from the overhead piping network to a coverage area of at least 144 square feet.

33. The fire protection method of claim 32, wherein the K-factor is at least 25.2

34. The fire protection method of claim 33, wherein the coverage area is at least 196 square feet.

35. The fire protection method of claim 34, wherein a design operating area of the sprinkler is up to 6 sprinklers per 1200 square feet.

36. The fire protection method of claim 33, wherein the fluid entering the sprinkler is at least 40 pounds per square inch.

37. The fire protection method of claim 36, wherein a design operating area of the sprinkler is up to 9 sprinklers per 1200 square feet.

38. The fire protection method of claim 33, wherein the fluid fed to the sprinkler is at least 60 pounds per square inch.

39. The fire protection method of claim 38, wherein the storage height is at least 35 feet and the building height is at least 40 feet.

40. The fire protection method of claim 39, wherein a design operating area of the sprinkler is up to 14 sprinklers.

41. A control mode extended coverage specific application fire protection sprinkler for storage applications that connects to a piping network to protect commodity hazards, the sprinkler comprising:
a body defining a passageway between an inlet and an outlet along a longitudinal axis with the outlet closer to an area to be protected than the inlet, the passageway having a rated K-factor of at least 14;
a closure positioned proximate the outlet opening so as to occlude the passageway in an unactuated position;
a heat responsive trigger that retains the closure to occlude the passageway; and
a deflector assembly that distributes fluid fed to the inlet at a certain pressure while providing coverage of at least up to 144 square feet to protect an occupancy hazard including classes I-IV and Group A cartoned unexpanded plastics, as defined by National Fire Protection Association Standard 13 and FM Global Property Loss Prevention Data Sheets 8-1 and 8-9, stored in a storage area defined by a storage height of at least 25 feet, and a building height of at least 30 feet when the heat responsive trigger is actuated to permit flow through the outlet.

42. The sprinkler according to claim 42, wherein the K-factor is at least 25. 2.

43. The sprinkler according to claim 42, wherein the fluid fed to the inlet is at least 30 pounds per square inch gauge.

44. The sprinkler according to claim 43, wherein the sprinkler provides coverage of at least 196 square feet.

45. The sprinkler according to claim 43, wherein a design operating area of the sprinkler is up to 6 sprinklers per 1200 square feet.

46. The sprinkler according to claim 42, wherein the pressure of the fluid fed to the inlet is at least 40 pounds per square inch gauge.

47. The sprinkler according to claim 46, wherein the storage height is at least 30 feet and the building height is at least 35 feet.

48. The sprinkler according to claim 46, wherein a design operating area of the sprinkler is up to 9 sprinklers per 1200 square feet.

49. The sprinkler according to claim 42, wherein the fluid fed to the inlet is at least 60 pounds per square inch gauge.

50. The sprinkler according to claim 49, wherein the storage height is at least 35 feet and the building height is at least 40 feet.

51. The sprinkler according to claim 50, wherein coverage is at least 144 square feet.

51. The sprinkler of claim 20, wherein the corner slots extend radially inward toward a sprinkler axis at least as far as a diameter of the hub.

52. The sprinkler of claim 16, wherein the corner slots are about 24.5% longer than the aligned slots.

53. The sprinkler according to claim 1, wherein the sprinkler is configured in compliance with FM Global Property Loss Prevention Data Sheet 2-7.

54. The sprinkler according to claim 1, wherein the sprinkler has a hose stream allowance of 250 gallons per minute with a minimum fluid supply duration to the sprinkler of about 1 hour when a demand area is 1200 square feet or less and has a hose stream allowance of 500 gallons per minute with a minimum fluid supply duration to the sprinkler of about 1.5 hours when a demand area is greater than 1200 square feet.

55. The sprinkler according to claim 1, wherein the deflector is configured to be disposed at least 3 feet above the occupancy hazard and at least 3 feet away from any obstruction.

56. The sprinkler according to claim 55, wherein the deflector is further configured to be disposed above the occupancy hazard configured as at least two double row storage racks separated by an aisle having a minimum width of 4 feet.

57. The sprinkler according to claim 16, wherein the sprinkler is configured in compliance with FM Global Property Loss Prevention Data Sheet 2-7.

58. The sprinkler according to claim 16, wherein the sprinkler has a hose stream allowance of 250 gallons per minute with a minimum fluid supply duration to the sprinkler of about 1 hour when a demand area is 1200 square feet or less and has a hose stream allowance of 500 gallons per minute with a minimum fluid supply duration to the sprinkler of about 1.5 hours when a demand area is greater than 1200 square feet.

59. The sprinkler according to claim 16, wherein the deflector is configured to be disposed at least 3 feet above the occupancy hazard and at least 3 feet away from any obstruction.

60. The sprinkler according to claim 59, wherein the deflector is further configured to be disposed above the occupancy hazard configured as at least two double row storage racks separated by an aisle having a minimum width of 4 feet.

61. The fire protection method of claim 32, wherein a sprinkler is provided that is configured to be in compliance with FM Global Property Loss Prevention Data Sheet 2-7.

62. The fire protection method according to claim 32, wherein connecting further includes connecting the sprinkler at least 3 feet above the storage height and at least 3 feet away from any obstruction.

63. The fire protection method according to claim 60, wherein the commodity occupancy hazard is configured as at least two double row storage racks separated by an aisle having a minimum width of 4 feet.

64. The sprinkler according to claim 41, wherein the sprinkler is configured in compliance with FM Global Property Loss Prevention Data Sheet 2-7.

65. The sprinkler according to claim 41, wherein the sprinkler has a hose stream allowance of 250 gallons per minute with a minimum fluid supply duration to the sprinkler of about 1 hour when a demand area is 1200 square feet or less and has a hose stream allowance of 500 gallons per minute with a minimum fluid supply duration to the sprinkler of about 1.5 hours when a demand area is greater than 1200 square feet.

66. The sprinkler according to claim 41, wherein the deflector is configured to be disposed at least 3 feet above the occupancy hazard and at least 3 feet away from any obstruction.

67. The sprinkler according to claim 66, wherein the deflector is further configured to be disposed above the occupancy hazard configured as at least two double row storage racks separated by an aisle having a minimum width of 4 feet.

68. The sprinkler according to claim 41, wherein the sprinkler has a K-factor of 14-28.
